(19) United States
(12) Patent Application Publication
(10) Pub. No.: US 2009/0066645 A1
(43) Pub. Date: Mar. 12, 2009

(54) WIRELESS MOUSE WITH ALPHANUMERIC KEYPAD

(76) Inventor: Young S. KIM, Los Altos, CA (US)

Correspondence Address: Dorsey & Whitney LLP;US Bank Center, 1420 Fifth Avenue, Suite 3400, Seattle, WA, 98101-4010, US

(21) Appl. No.: 11/853,783

(22) Filed: Sep. 11, 2007

(51) Int. Cl. G06F 3/033

(52) U.S. Cl. 345/158

(57) ABSTRACT

A wireless mouse for use by a hand of a user with a computer and a display having a cursor that includes a hand-holdable housing and a battery carried within the housing. An integrated circuit is carried within the housing and includes radio communications circuitry adapted for communicating with the computer. At least one sensor is carried by the housing for moving the cursor across the display and at least one button is provided on the housing for clicking on objects on the display. An alphanumeric keypad is provided on the housing for typing on the display.

### FIELD OF THE INVENTION

The present invention relates generally to a computer mouse and more particularly to a wireless computer mouse.

### BACKGROUND INFORMATION

Numerous types of mouse have heretofore been provided for use with computer systems that include a microprocessor and display. Many of such mouse operate wirelessly, which can be beneficial when being used during presentations. Laser pointers and presenters have also been provided for use during presentations. In addition, wireless keyboards have been provided. There is a need, however, for a wireless mouse that includes a variety of the functions of these devices.

### SUMMARY OF THE INVENTION

A wireless mouse for use by a hand of a user with a computer and a display having a cursor is provided and includes a hand-holdable housing and a battery carried within the housing. An integrated circuit is carried within the housing and includes radio communications circuitry adapted for communicating with the computer. At least one sensor is carried by the housing for moving the cursor across the display and at least one button is provided on the housing for clicking on objects on the display. An alphanumeric keypad is provided on the housing for typing on the display.

### BRIEF DESCRIPTION OF THE DRAWINGS

The accompanying drawings, which are somewhat schematic in some instances and are incorporated in and form a part of this specification, illustrate several embodiments of the invention and, together with the description, serve to explain the principles of the invention.

FIG. 1 is a front perspective view of the wireless mouse with alphanumeric keypad of the present invention.

FIG. 2 is a rear perspective view of the wireless mouse with alphanumeric keypad of FIG. 1 taken along the line 2-2 of FIG. 1.

FIG. 3 is a first side elevational view of the wireless mouse with alphanumeric keypad of FIG. 1 taken along the line 3-3 of FIG. 1.

FIG. 4 is a second side elevational view of the wireless mouse with alphanumeric keypad of FIG. 1 taken along the line 4-4 of FIG. 1.

FIG. 5 is a front perspective view of the wireless mouse with alphanumeric keypad of FIG. 1 taken along the line 5-5 of FIG. 1.

### DETAILED DESCRIPTION OF EMBODIMENTS OF THE INVENTION

Wireless mouse 11 of the present invention is a hand-holdable device for use with a computer (not shown) and a display (not shown) having a cursor controlled by the computer and movable on the display. Mouse 11 has a housing 12 made from any suitable material such as plastic or metal and is of any suitable size and shape. In one embodiment, housing 12 has a slim bar-type configuration and in that regard is shaped as a parallelepiped provided with upper and lower planar surfaces 13 and 14 extending parallel to each other and first and second side surfaces 16 and 17 extending parallel to each other and extending substantially perpendicular to upper and lower surfaces 13 and 14. The housing 12 is further provided with a front end surface 18 and an opposite rear end surface 19. In one preferred embodiment, housing 11 has a length between end surfaces 18 and 19 of approximately 86 millimeters, a width between side surfaces 16 and 17 of approximately 43 millimeters and a thickness between upper and lower surfaces 13 and 14 of approximately 12 millimeters.

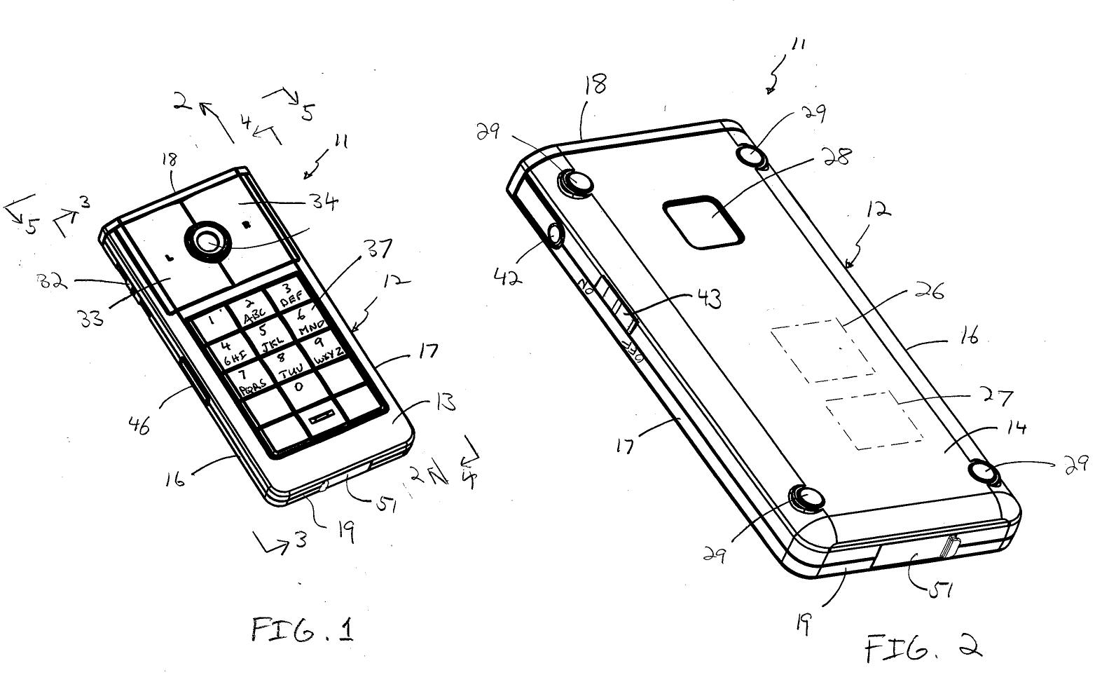

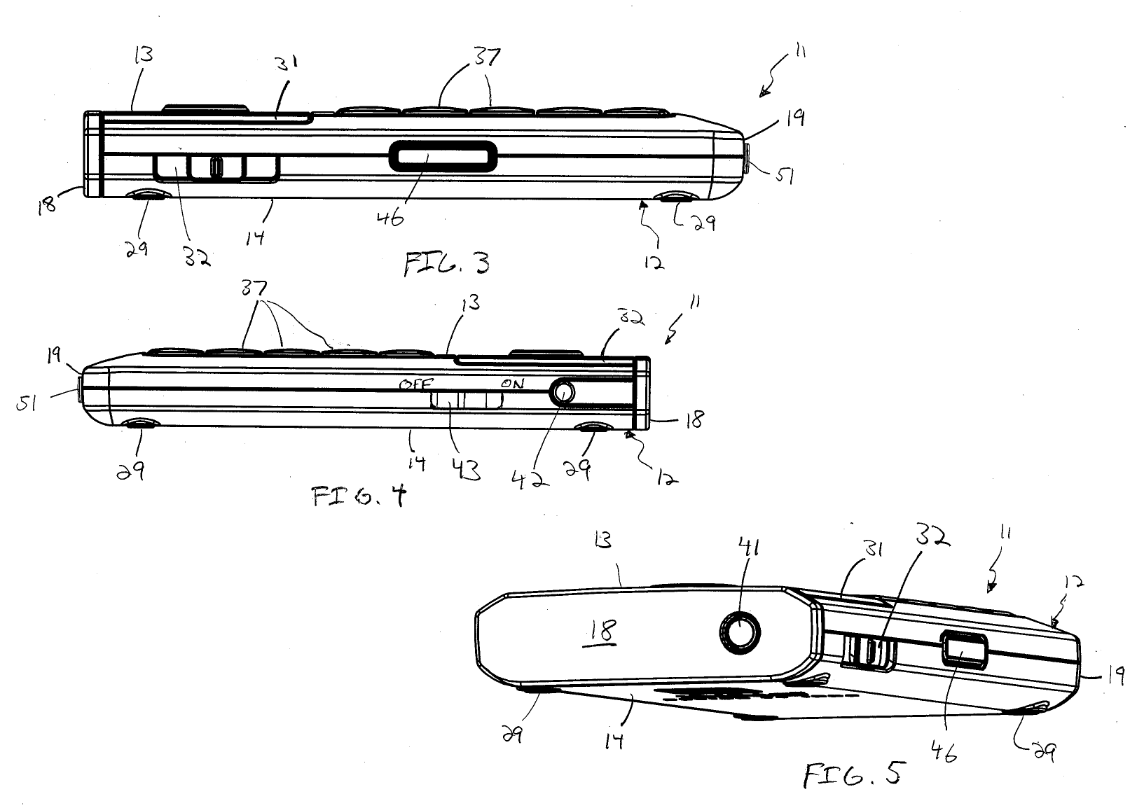

At least one integrated circuit or module 26 is carried within housing 12 and includes radio communications circuitry adaptive for communicating with the computer. Although any suitable circuitry and related standard can be utilized, in one preferred embodiment of the invention the radio communications circuitry enables short wave radio, such as Bluetooth, communication between the mouse 11 and the computer to which it has been programmed for use. Bluetooth is an industrial specification for wireless personal area networks developed and licensed by the Bluetooth Special Interest Group headquartered in Bellevue, Wash. A battery 27 is carried within the housing and electrically coupled to integrated circuit 26 and the other electrical components within the housing 12 for providing power to such components. Integrated circuit 26 and battery 27 are shown schematically in dashed lines in FIG. 2.

At least one sensor is carried by the housing for moving the cursor across the display of the computer system. In one embodiment, a first sensing system is included within mouse 11 for use in moving the cursor on the display and includes an optical sensor 28 provided on the underside of housing 12 and more specifically on lower surface 14 adjacent the upper end of the housing (see FIG. 2). The optical sensor 28 is used in a conventional manner when mouse 11 is placed upon a support or other reference surface (not shown) and moved thereacross to move the cursor. A pad 29 is provided on each corner of the lower surface 14 of housing 12 for engaging the reference surface and stabilizing the housing 12 with respect to the reference surface. A second sensing system can optionally be included within mouse 11 for use in moving the cursor on the display when the housing 12 is used in a hand-held operation and thus free of a reference surface. In this regard, a sensor in the form of a finger-operable member 31 is provided on upper surface 13 of the housing, preferably in the vicinity of the front end surface 18, for use in moving the cursor on the display. The finger-operable member 31 can be of any suitable type and in one preferred embodiment is a pointing stick. In another suitable embodiment, the finger-operable member 31 can be a trackball. A mode switch 32 is provided on first side surface 16 adjacent front end surface 18 for permitting the user to elect whether to control the movement of the cursor by either optical sensor 28, for example when mouse 11 is used with a reference surface, or finger-operable member 31, for example when mouse 11 is being held by the user. Mouse 11 further includes at least one button and preferably left and right buttons 33 and 34 on upper surface 13 for clicking on objects identified by the cursor on the display and for enabling tasks with respect to such objects in a conventional manner. Buttons 33 and 34 are preferably located on opposite sides of the finger-operable member.

Mouse 11 is provided with a alphanumeric keypad 37, for example the type found on mobile communications devices such as cell phones, for permitting the typing of messages on the display or elsewhere.

Mouse 11 can be used as a pointer and in this regard is provided with a laser 41 on front end surface 18 (see FIG. 5). A button 42 is provided on second side surface 17 for activating and deactivating the laser 41.

Other control buttons and switches provided on housing 12 for operating mouse 11 include an on/off switch 43 provided on second side surface 17, adjacent laser button 42, for activating and deactivating the mouse 11, and a function button 46 provided on first side surface 16 for toggling between various functions of the mouse 11.

A sliding door 51 is provided on rear end surface 19. When opened, door 51 reveals a recessed connector (not shown) for permitting mouse 11 to be hardwired to a computer or other device. In one preferred embodiment, the connector is a conventional USB connector.

In operation and use, mouse 11 can be used on a support or other reference surface or in a hand-held mode free of a reference surface for serving as a mouse to move a cursor across a display and to click on items on the display. When used on a surface, optical sensor 28 can utilized for moving the cursor. When the mouse 11 is held by the hand of the user free of a reference surface, finger-operable member 31 can be utilized for moving the cursor across the display. If the user desires to enter text or deliver a message on the computer display, the alphanumeric key pad 37 can be activated and used to enter and display numbers and/or letters on the display, for example in accordance with a short messaging system protocol. Mouse 11 can be further utilized as a laser pointer by pushing on button 42 when desired and moving the housing accordingly.

The foregoing descriptions of specific embodiments and best mode of the present invention have been presented for purposes of illustration and description only. They are not intended to be exhaustive or to limit the invention to the precise forms disclosed. Specific features of the invention are shown in some drawings and not in others, for purposes of convenience only, and any feature may be combined with other features in accordance with the invention. Steps of the described processes may be reordered or combined, and other steps may be included. The embodiments were chosen and described in order to best explain the principles of the invention and its practical application, to thereby enable others skilled in the art to best utilize the invention and various embodiments with various modifications as are suited to the particular use contemplated. Further variations of the invention will be apparent to one skilled in the art in light of this disclosure and such variations are intended to fall within the scope of the appended claims and their equivalents.

What is claimed is:

1. A wireless mouse for use by a hand of a user with a computer and a display having a cursor thereon comprising a hand-holdable housing, a battery carried within the housing, an integrated circuit carried within the housing and including radio communications circuitry adapted for communicating with the computer, at least one sensor carried by the housing for moving the cursor across the display, at least one button provided on the housing for clicking on objects on the display and an alphanumeric keypad provided on the housing for typing on the display.

2. The mouse of claim 1 wherein housing has an underside and the at least one sensor includes an optical sensor provided on the underside of the housing for use when the housing is used with a reference surface.

3. The mouse of claim 1 wherein the at least one sensor includes a finger-operable member provided on the housing for use when the housing is held in the hand of the user free of a reference surface.

4. The mouse of claim 3 wherein the finger-operable member is a pointing stick.

5. The mouse of claim 3 wherein the finger-operable member is a trackball.

6. The mouse of claim 1 further comprising a laser carried by the housing for permitting the mouse to be used as a pointer.
